(19) United States
(12) Patent Application Publication
(10) Pub. No.: US 2017/0107916 A1
(43) Pub. Date: Apr. 20, 2017

(54) CONTROL SYSTEM OF INTERNAL COMBUSTION ENGINE

(71) Applicant: TOYOTA JIDOSHA KABUSHIKI KAISHA, Toyota-shi (JP)

(72) Inventor: Yukihiro NAKASAKA, Shizuoka-ken (JP)

(73) Assignee: TOYOTA JIDOSHA KABUSHIKI KAISHA, Toyota-shi (JP)

(21) Appl. No.: 15/294,940

(22) Filed: Oct. 17, 2016

(30) Foreign Application Priority Data
Oct. 19, 2015 (JP) 2015-205947

(51) Int. Cl. F02D 13/02; F02D 41/30

(52) U.S. Cl. CPC F02D 13/0234; F02D 41/3005

(57) ABSTRACT

A control system according to one aspect of the present invention is applied to an engine. The engine comprises a port injector and an intake valve driving device capable of changing the closing timing of the intake valve. The engine, if an execution condition for performing a fuel cut control is satisfied when performing an Atkinson cycle, executes the fuel cut control after advancing the closing timing of the intake valve. As a result, by reducing the amount of the fuel which is blown back to the inside of the intake passage in a period where the intake valve is open after intake bottom dead center, the amount of the fuel which flows into the exhaust passage as unburned gas when the fuel cut control is executed can be reduced.

### TECHNICAL FIELD

The present invention relates to a control system of an internal combustion engine comprising an intake valve driving device capable of changing a closing timing of an intake valve.

### BACKGROUND ART

Known in the past has been a control system of a spark-ignition type internal combustion engine which comprises an intake port injector injecting fuel into an intake port and an intake valve driving device capable of changing a closing timing of the intake valve, and performs an Atkinson cycle improving an engine efficiency by making an expansion ratio larger compared with a compression ratio (for example, see PLT 1).

The system disclosed in PLT 1 (Below, referred to as the “conventional system”) is configured to set the closing timing of the intake valve to a time after intake bottom dead center and push back a part of the air once taken into a cylinder to the inside of the intake port so as to delay the compression start timing. Accordingly, in the conventional system, by delaying the compression start timing, an Atkinson cycle that makes the expansion ratio larger compared with the compression ratio is realized and thereby the engine efficiency is improved.

### CITATION LIST

### Patent Literature

PLT 1. Japanese Patent Publication No. 2000-073901A

### SUMMARY OF INVENTION

However, in the conventional device, when the closing timing of the intake valve becomes after intake bottom dead center in order to perform the Atkinson cycle, after the fuel injected from the intake port injector once flows into a cylinder, it is blown back to the inside of the intake port in a period when the intake valve is open after intake bottom dead center. At this time, if fuel cut control for suspending the fuel injection from the intake port injector is executed, the fuel which was blown back to the inside of the intake port before the fuel cut control will again flow into the cylinder during the fuel cut control. As a result, the air-fuel mixture which contains the fuel which again flowed into the cylinder during the fuel cut control is liable to not completely burn during the fuel cut control, but blow through as unburned gas to the inside of the exhaust passage.

The present invention is made in order to deal with the problems explained above. That is, one of the objects of the present invention is to provide a “control system of an internal combustion engine” (below, referred to as the “system of the present invention”) which comprises an intake valve driving device capable of changing the closing timing of the intake valve, is applied to an internal combustion engine for realizing the Atkinson cycle, and suppresses blow through of the unburned gas to the exhaust passage when performing fuel cut control.

The system of the present invention is applied to an internal combustion engine comprising a fuel injection device injecting fuel into a cylinder or intake passage in the period when the intake valve is open, and an intake valve driving device capable of changing the closing timing of the intake valve.

Further, the system of the present invention comprises a valve closing timing controlling means and a fuel cut controlling means. The valve closing timing controlling means is configured to switch the closing timing of the intake valve to a first valve closing timing which is after intake bottom dead center and to a second valve closing timing which is a timing advanced compared with the first valve closing timing.

The fuel cut controlling means is configured to perform a fuel cut control for suspending the injection of fuel from the fuel injection device.

Further, the system of the present invention is configured to execute the fuel cut control after switching the closing timing of the intake valve to the second valve closing timing if the above execution condition is satisfied when the closing timing of the intake valve is the first valve closing timing.

According to this, since the closing timing of the intake valve is advanced, the amount of the fuel which is blown back to the inside of the intake passage during the period when the intake valve is open after intake bottom dead center decreases. As a result, the amount of the fuel which flows into the exhaust passage as the unburned gas when the fuel cut control is carried out can be reduced.

In this regard, the fuel injected from the fuel injection device is blown back to the inside of the intake passage in the period when the intake valve is open after intake bottom dead center. Therefore, one aspect of the system of the present invention is configured so that the second valve closing timing becomes before intake bottom dead center.

According to this, since the second valve closing timing is set to a time before intake bottom dead center, the period when the intake valve is open after intake bottom dead center becomes zero. Accordingly, the amount of the fuel blown back to the inside of the intake passage can be further reduced compared with the case where the second valve closing timing is after intake bottom dead center. As a result, when fuel cut control is carried out, the amount of the fuel which flows into the exhaust passage as unburned gas can be reduced compared with the case where the second valve closing timing is after intake bottom dead center.

Further, a part of the fuel which is blown back to the inside of the intake passage at the first valve closing timing is liable to remain in the intake passage even after the change to the second valve closing timing. Therefore, in one aspect of the system of the present invention, the fuel cut controlling means is configured to perform the fuel cut control after a predetermined period has passed from the change of the closing timing of the intake valve to the second valve closing timing.

According to this, by performing the fuel cut control after a predetermined period has passed from the change to the second valve closing timing, the amount of fuel in the fuel which was blown back to the inside of the intake passage at the first valve closing timing, which remains in the intake passage even after the change to the second valve closing timing, can be reduced. As a result, the amount of the fuel which flows into the exhaust passage as unburned gas can be reduced compared with the case where the fuel cut control is executed immediately after switching to the second valve closing timing.

Other objects, features, and accompanying advantages of the present invention will be easily understood from the explanation of embodiments of the present invention given with reference to the following drawings.

### BRIEF DESCRIPTION OF DRAWINGS

FIG. 1 is a schematic view of an internal combustion engine according to an embodiment of the present invention.

FIG. 2 is a view of valve characteristics of an intake valve according to an embodiment of the present invention.

FIG. 3 is a timing chart of fuel cut control according to an embodiment of the present invention.

FIG. 4 is a flow chart showing a routine of fuel cut control which is executed by a CPU of a first system.

### DESCRIPTION OF EMBODIMENTS

Below, the “control system of an internal combustion engine according to the present invention” (below, sometimes referred to as the “present control system”) will be explained with reference to the drawings.

[Schematic Configuration]

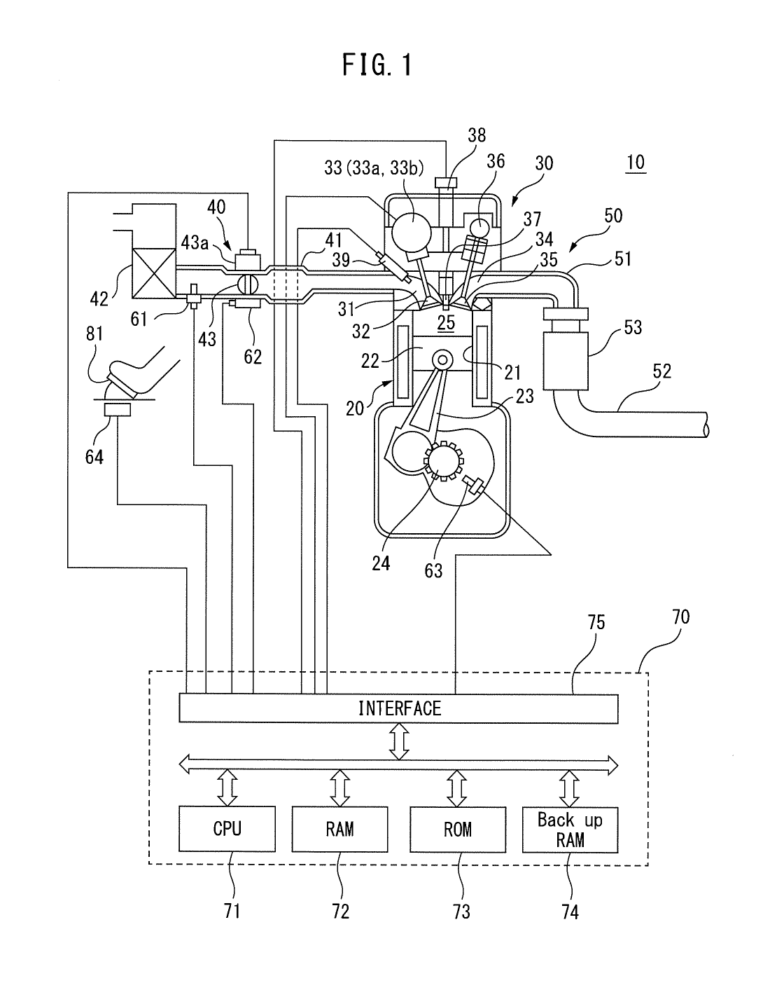

The present control system is applied to a spark ignition type multi-cylinder internal combustion engine 10 (below, referred to as the “engine”) shown in FIG. 1. Note that, FIG. 1 shows only the cross-section of a specific cylinder, but other cylinders are provided with the same configuration as well.

This engine 10 includes a cylinder block 20, a cylinder head 30 fixed on the cylinder block 20, an intake system 40 for supplying air to the cylinder block 20, and an exhaust system 50 for discharging the exhaust gas from the cylinder block 20 to the outside.

The cylinder block 20 includes a cylinder 21, a piston 22, a connecting rod 23, and a crank shaft 24. The piston 22 reciprocally moves inside the cylinder, the reciprocating movement of the piston 22 is transmitted through the connecting rod 23 to the crank shaft 24, and thereby the crank shaft 24 rotates. The top face of the piston 22, the wall surface of the cylinder 21, and the bottom surface of the cylinder head 30 define a combustion chamber 25.

The cylinder head 30 comprises an intake port 31 communicated with the combustion chamber 25, an intake valve 32 opening and closing the intake port 31, an intake valve driving device 33 driving the intake valve 32 and being able to change the valve characteristic of the intake valve 32, an exhaust port 34 communicated with the combustion chamber 25, an exhaust valve 35 opening and closing the exhaust port 34, an exhaust camshaft 36 driving the exhaust valve 35, a spark plug 37, an ignitor 38 including an ignition coil for generating a high voltage to be given to the spark plug 37, and a fuel injector 39 injecting the fuel into the intake port 31. The fuel injector 39 controls the injection of the fuel so that the fuel is supplied to the inside of the combustion chamber 25 in the period when the intake port 31 is open, i.e., in the intake stroke.

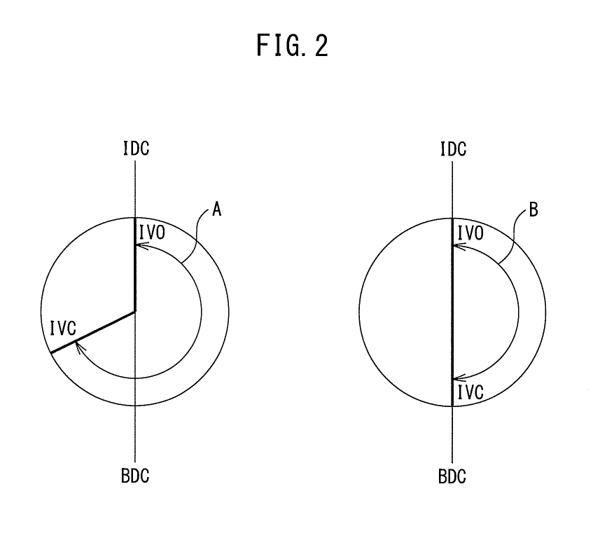

The intake valve driving device 33 is a variable valve drive mechanism having the function of switching the valve characteristic of the intake valve 32 to two types of valve characteristics. A in FIG. 2 represents a case where the valve characteristic of the intake valve 32 becomes a first valve characteristic. The first valve characteristic is the valve characteristic of a large working angle 32a. The intake valve opening timing IVO is the timing of intake top dead center TDC, while the intake valve closing timing IVC is the timing after intake bottom dead center BDC (for example ABDC 60 to 70° after bottom dead center). B in FIG. 2 represents a second valve characteristic. The second valve characteristic is the valve characteristic of a small working angle 32b. The intake valve opening timing IVO is the timing of intake top dead center TDC, while the intake valve closing timing IVC is the timing of bottom dead center BDC.

The intake system 40 comprises an intake pipe 41 including an intake manifold which is communicated with the intake port 31 and forms the intake passage together with the intake port 31, an air filter 42 provided at the end part of the intake pipe 41, a throttle valve 43 which is located in the intake pipe 41 and makes the opening cross-section of the intake passage variable, and a throttle valve actuator 43a which configures the throttle valve driving means.

The exhaust system 50 has an exhaust manifold 51 communicated with the exhaust port 34, an exhaust pipe 52 connected to the exhaust manifold 51, and a three-way catalyst 53 arranged on the exhaust pipe 52.

On the other hand, this system comprises a hot wire air flow meter 61, throttle position sensor 62, crank position sensor 63 and accelerator opening sensor 64.

The hot wire air flow meter 61 detects a mass flow rate per unit time of the intake air flowing in the intake pipe 41 and outputs a signal representing the mass flow rate Ga.

The throttle position sensor 62 detects the degree of opening of the throttle valve 43 and outputs a signal representing the throttle valve opening TA.

The crank position sensor 63 is configured to output a pulse whenever the crank shaft 24 rotates by 10 degrees. The pulse output from the crank position sensor 63 is converted to a signal representing the engine rotation speed NE by an electronic control unit 70 which will be explained later. Further, the electronic control unit 70 calculates the crank angle (absolute crank angle θ) of the engine 10 based on the signal from the crank position sensor 63.

The accelerator opening sensor 64 detects the accelerator opening of the accelerator pedal 81 operated by the driver and outputs a signal representing the accelerator opening Accp of the accelerator pedal 81. The accelerator opening Accp of the accelerator pedal 81 is one parameter representing the magnitude of the load of the engine 10.

The electronic control unit 70 is a known microprocessor including a CPU 71, ROM 72, RAM 73, backup RAM 74, interface 75 including an AD converter, etc.

The interface 75 is connected to the sensors 61 to 64 described above and is configured to supply the signals from these sensors to the CPU 71. Further, the interface 75, in response to an instruction from the CPU 71, outputs drive signals to the intake valve driving device 33 and throttle valve actuator 43a, outputs an injection instruction signal to the cylinder injector 39 of each cylinder, and outputs an ignition signal to the ignitor 38 of each cylinder.

The present control system performs an “Atkinson cycle” by switching the valve characteristic of the intake valve 32. Further, the present control system performs “fuel cut control” suspending fuel injection from the fuel injector 39. Further, if the execution condition explained later is satisfied at the time when the Atkinson cycle is carried out, the present control system does not perform the fuel cut control until the closing timing of the intake valve 32 is advanced. For this reason, below, the Atkinson cycle and fuel cut control will be explained in order.

[Atkinson Cycle]

The Atkinson cycle is a cycle making the expansion ratio in the engine 10 larger compared with the compression ratio. In the present control system, this is realized by setting the closing timing of the intake valve 32 at the time after intake bottom dead center. Specifically, the present control system sets the valve characteristic of the intake valve 32 to the first valve characteristic by the intake valve driving device 33. According to this, the closing timing of the intake valve 32 becomes a time after intake bottom dead center, so the expansion ratio can be made larger compared with the compression ratio (i.e., the Atkinson cycle can be achieved) and therefore the engine efficiency of the engine 10 can be improved.

[Fuel Cut Control]

The CPU 71 provided in the electronic control unit 70 of the present control system performs a fuel cut control suspending the fuel injection by the fuel injector 39 when the engine 10 becomes a predetermined execution condition. The predetermined execution condition (below, referred to as the “execution condition”) is for example a case where the output torque of the engine 10 is reduced. Specifically, when the accelerator opening Accp of the accelerator pedal 81 becomes a predetermined amount or less (for example, Accpoff at which the accelerator opening becomes zero), the present control system judges that the execution condition is satisfied and performs the fuel cut control. The CPU 71 can smoothly reduce the output torque of the engine 10 by the fuel cut control and can improve the fuel economy by suppressing unnecessary fuel consumption.

Further, the CPU 71 is configured not to execute the fuel cut control until the intake valve 32 switches to the second valve characteristic and a predetermined period has passed, if the execution condition is satisfied when the intake valve 32 has the first valve characteristic. In other words, if the execution condition is satisfied when the valve characteristic of the intake valve 32 is the first valve characteristic, the CPU 71 executes the fuel cut control after an elapse of a predetermined period after the valve characteristic of the intake valve 32 is switched to the second valve characteristic.

Specifically explaining this, if the opening Accp of the accelerator pedal 81 becomes Accpoff when the intake valve 32 has the first valve characteristic, the ECU 71 judges that the execution condition is satisfied. Next, the ECU 71 switches the intake valve 32 to the second valve characteristic by driving the intake valve driving device 33. Next, the ECU 71 suspends the fuel injection (i.e., executes the fuel cut control) from the fuel injector 39 after an elapse of the predetermined period from the switching to the second valve characteristic up to when the amount of the fuel remaining in the intake passage decreases and becomes constant.

According to this, by switching the valve characteristic of the intake valve 32 from the first valve characteristic to the second valve characteristic, the valve opening period of the intake valve 32 after intake bottom dead center becomes short. Accordingly, the period where the fuel is blown back to the inside of the intake passage becomes short, therefore the amount of the fuel which is blown back to the inside of the intake passage can be made small. As a result, the amount of the fuel which flows into the exhaust passage as the unburned gas when the fuel cut control is executed can be reduced. Further, in the present control system, the fuel cut control is executed after the predetermined period has passed, which is up to when the amount of the fuel remaining in the intake passage decreases and becomes constant. As a result, the amount of the fuel which flows into the exhaust passage as the unburned gas can be reduced compared with the case where the fuel cut control is executed at the time of switching to the second valve closing timing.

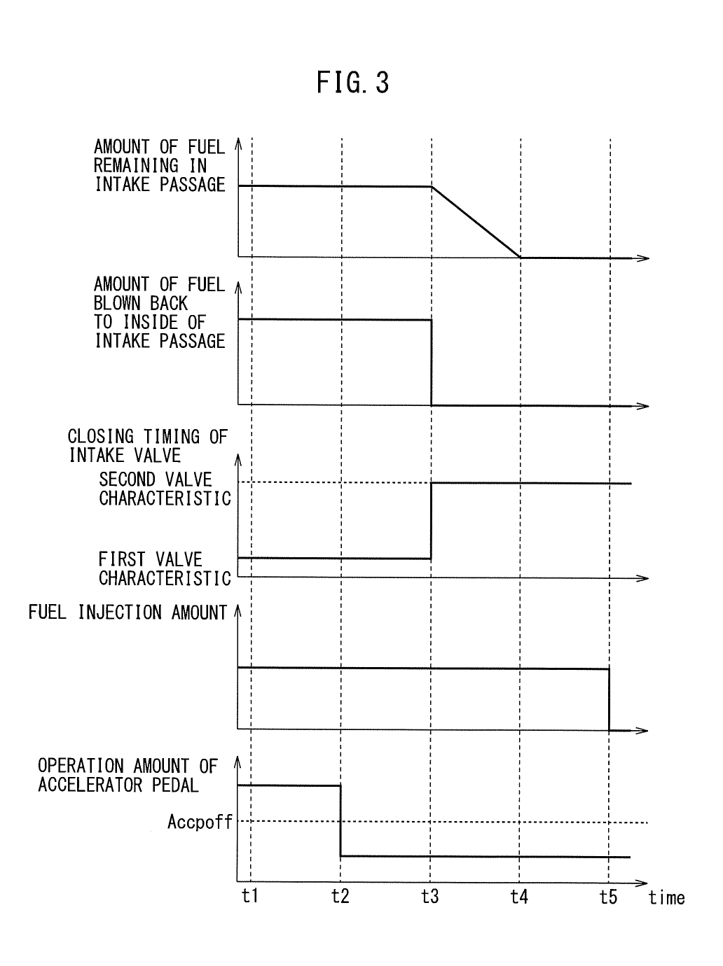

Next, the fuel cut control which is actually carried out by the electronic control unit 70 in the present control system will be explained with reference to the timing chart in FIG. 3. FIG. 3 shows a change according to time in the amount of the fuel which remains in the intake passage, a change according to time in the amount of the fuel which is blown to the inside of the intake passage, and a change according to time in the closing timing of the intake valve 32. Further, FIG. 3 shows a change according to time in the fuel injection amount from the fuel injector 39 and a change according to time in the opening Accp of the accelerator pedal 81.

In the period from the time t1 to the time t2, the accelerator opening Accp of the accelerator pedal 81 has become larger than Accpoff at which the accelerator opening becomes zero, therefore the execution condition is not satisfied. At the time t2, the accelerator opening Accp of the accelerator pedal 81 becomes Accpoff at which the accelerator opening becomes zero, so it is judged that the execution condition is satisfied. After that, at the time t3, by switching the valve characteristic of the intake valve 32 from the first valve characteristic to the second valve characteristic, the closing timing of the intake valve switches to intake bottom dead center. Along with the switching of the valve characteristic of the intake valve 32, the amount of the fuel which is blown back to the inside of the intake passage decreases. In the period from the time t3 to the time t4, the amount of the fuel which remains in the intake passage decreases compared with the case where the valve characteristic of the intake valve 32 is the first valve characteristic, and becomes constant. After that, by execution of the fuel cut control at the time t5, the fuel injection amount from the fuel injector 39 becomes zero.

[Actual Operation of Present Control System]

Next, the actual operation of the present control system will be explained.

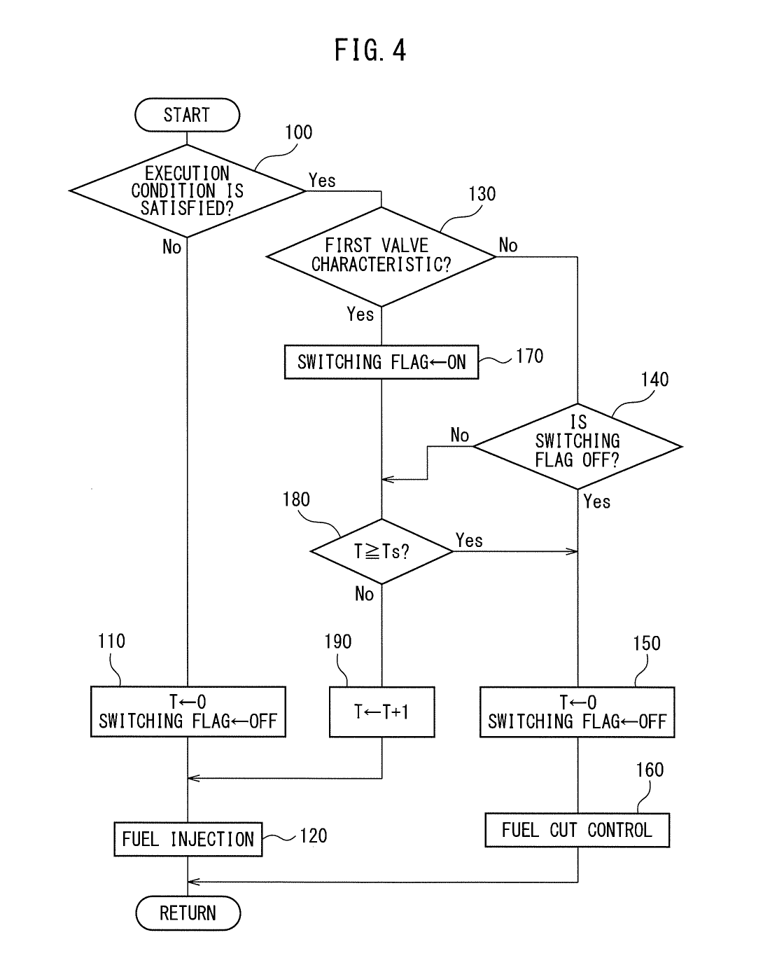

The CPU 71 of the present control system (below, referred to as the “CPU”) executes the fuel cut control routine shown in the flow chart in FIG. 4 at each predetermined timing after the start of the engine. Accordingly, the CPU starts the processing of step 100 at a suitable timing and judges whether the execution condition is satisfied. Here, a case where the execution condition is not satisfied will be explained first.

If the execution condition is not satisfied, the CPU judges “No” at step 100 and sets the “elapsed time period T”, which is the time period passed from the switching of the valve characteristic of the intake valve 32 from the first valve characteristic to the second valve characteristic at step 110, to 0. Further, at step 110, the CPU sets the “switching flag” which shows switching of the valve characteristic of the intake valve 32 from the first valve characteristic to the second valve characteristic to OFF.

After execution of the processing at step 110, at step 120, the CPU sets the system so as to execute the fuel injection from the fuel injector 39, then ends the present routine.

Next, a case where the execution condition is satisfied, the switching flag is OFF, and the valve characteristic of the intake valve 32 is the second valve characteristic will be explained. The CPU judges “YES” and executes the processing of step 130, since the execution condition is satisfied at step 100. At step 130, the CPU judges whether the valve characteristic of the intake valve 32 is the first valve characteristic.

Since the valve characteristic of the intake valve 32 is the second valve characteristic, the CPU judges “NO” at step 130 and judges whether the switching flag is OFF at step 140. It is judged that the switching flag is OFF, since the valve characteristic of the intake valve 32 has not been switched from the first valve characteristic to the second valve characteristic. Therefore, the CPU judges the processing of step 140 as “Yes”, then proceeds to step 150.

At step 150, the CPU sets the elapsed time period T to 0 and sets the switching flag to OFF.

After execution of the processing of step 150, the CPU executes the fuel cut control at step 160, then ends the present routine.

Next, a case where the execution condition is satisfied and the valve characteristic of the intake valve 32 is the first valve characteristic will be explained. The CPU executes the processing of steps 100 and 130 in order. Since the valve characteristic of the intake valve 32 is the first valve characteristic, the CPU judges the processing of step 130 as “Yes”, then proceeds to step 170.

In the processing of step 170, the CPU switches the valve characteristic of the intake valve 32 from the first valve characteristic to the second valve characteristic and sets the switching flag to ON.

After execution of the processing of step 170, at step 180, the CPU judges whether the elapsed time period T is the predetermined time period Ts or more. The predetermined time period Ts is the time period which is set in advance so as to become a time period from switching of the valve characteristic of the intake valve 32 from the first valve characteristic to the second valve characteristic to when the amount of the fuel remaining in the intake passage decreases and becomes constant.

Usually, immediately after switching the valve characteristic of the intake valve 32 from the first valve characteristic to the second valve characteristic, the elapsed time period T becomes less than the predetermined time period Ts, therefore the CPU judges the processing of step 180 as “No” and executes the processing of step 190. At step 190, the CPU updates the elapsed time period T by adding 1 to the current elapsed time period T.

After execution of the processing of step 190, at step 120, the CPU sets the system so as to execute the fuel injection from the fuel injector 39, then ends the present routine.

Next, a case where the execution condition is satisfied and the predetermined time period Ts or more has passed from when the valve characteristic of the intake valve 32 is switched from the first valve characteristic to the second valve characteristic will be explained. The CPU executes the processing of step 100 and step 130 in order and judges the processing of step 130 as “Yes”, since the valve characteristic of the intake valve 32 has switched from the first valve characteristic to the second valve characteristic, then proceeds to the processing of step 140.

At step 140, the CPU judges whether the switching flag is OFF. Since the valve characteristic of the intake valve 32 has switched from the first valve characteristic to the second valve characteristic, the CPU judges the processing of step 140 as “No”, then proceeds to the processing of step 180.

Since the elapsed time period T has become predetermined time period Ts or more, the CPU judges the processing of step 180 as “Yes” and, at step 150, sets the elapsed time period T to 0 and sets the switching flag to OFF.

After execution of the processing of step 150, the CPU executes the fuel cut control at step 160, then ends the present routine.

As explained above, according to the present control system, the valve closing timing of the intake valve 32 is advanced by changing the closing timing of the intake valve 32 from the first valve closing timing to the second valve closing timing, therefore the amount of the fuel which is blown back to the inside of the intake passage in the period where the intake valve is open after intake bottom dead center decreases. As a result, the amount of the fuel which flows into the exhaust passage as unburned gas when fuel cut control is carried out can be reduced.

Note that, the present invention is not limited to the above embodiment. Various modifications can be made within the scope of the present invention. For example, in the embodiment described above, a configuration arranging the fuel injector in the intake port was employed, but the fuel injector may be arranged in the cylinder or may be arranged in both of the cylinder and intake port. Further, the internal combustion engine may be a variable compression ratio internal combustion engine capable of changing a mechanical compression ratio. In a variable compression ratio internal combustion engine, the mechanical compression ratio can be changed to make the amount of delay of the closing timing of the intake valve larger, therefore the amount of the fuel which is blown back to the inside of the intake passage becomes larger. Accordingly, by applying the present invention to a variable compression ratio internal combustion engine, the amount of the fuel which is blown back to the inside of the intake passage can be further reduced.

Further, in the present embodiment, as long as the intake valve driving device is configured to be able to change the closing timing of the intake valve 32, it may be configured to change the phase of the cam and is, for example, a VVT. Further, the valve closing timing of the second valve characteristic may be before intake bottom dead center or may be after intake bottom dead center as long as the valve closing timing is advanced compared with the first valve characteristic.

Further, in the present embodiment, a configuration executing the fuel cut control after a predetermined period passed was employed, but a configuration executing the fuel cut control at the time when the closing timing of the intake valve becomes a valve closing timing which is advanced compared with the first valve closing timing without waiting for the predetermined period may also be employed. Further, the predetermined period may be a time and may be a run cycle.

### REFERENCE SIGNS LIST

10 . . . internal combustion engine, 32 . . . intake valve, 33 . . . intake valve driving device, 39 . . . fuel injector, 70 . . . electronic control unit, and 71 . . . CPU.

1. A control system of an internal combustion engine comprising:
an intake valve,
a fuel injection device injecting fuel into a cylinder or intake passage in a period where the intake valve is open, and
an intake valve driving device capable of changing a closing timing of the intake valve, wherein the control system comprises:
a valve closing timing controlling means for controlling the intake valve driving device so as to switch the closing timing of the intake valve to a first valve closing timing which is after intake bottom dead center and to a second valve closing timing which is advanced compared with the first valve closing timing, and
a fuel cut controlling means for executing the fuel cut control for suspending the injection of fuel from the fuel injection device if a predetermined execution condition is satisfied, and
the control system is configured to execute a fuel cut control after switching the closing timing of the intake valve to the second valve closing timing if the execution condition is satisfied when the closing timing of the intake valve is the first valve closing timing.

2. The control system of an internal combustion engine according to claim 1, wherein the second valve closing timing is a timing before intake bottom dead center.

3. The control system of an internal combustion engine according to claim 1, wherein the fuel cut controlling means is configured to perform the fuel cut control after a predetermined period from the switching of the closing timing of the intake valve from the first valve closing timing to the second valve closing timing.

4. The control system of an internal combustion engine according to claim 2, wherein the fuel cut controlling means is configured to perform the fuel cut control after a predetermined period from the switching of the closing timing of the intake valve from the first valve closing timing to the second valve closing timing.

5. A control system of an internal combustion engine comprising:
an intake valve,
a fuel injection device injecting fuel into a cylinder or intake passage in a period where the intake valve is open,
an intake valve driving device capable of changing a closing timing of the intake valve, and,
an electronic control unit, wherein
the electronic control unit is configured to
control the intake valve driving device so as to switch the closing timing of the intake valve to a first valve closing timing which is after intake bottom dead center and to a second valve closing timing which is advanced compared with the first valve closing timing,
execute the fuel cut control for suspending the injection of fuel from the fuel injection device if a predetermined execution condition is satisfied, and
execute a fuel cut control after switching the closing timing of the intake valve to the second valve closing timing if the execution condition is satisfied when the closing timing of the intake valve is the first valve closing timing.

6. The control system of an internal combustion engine according to claim 5, wherein the second valve closing timing is a timing before intake bottom dead center.

7. The control system of an internal combustion engine according to claim 5, wherein the electronic control unit is configured to perform the fuel cut control after a predetermined period from the switching of the closing timing of the intake valve from the first valve closing timing to the second valve closing timing.

8. The control system of an internal combustion engine according to claim 6, wherein the electronic control unit is configured to perform the fuel cut control after a predetermined period from the switching of the closing timing of the intake valve from the first valve closing timing to the second valve closing timing.
